(19) United States
(12) Patent Application Publication
(10) Pub. No.: US 2005/0113114 A1
(43) Pub. Date: May 26, 2005

(54) Method and apparatus to provide efficient routing of packets for a network initiated data session

(75) Inventor: Sarvesh Asthana, San Diego, CA (US)

Correspondence Address: HARRINGTON & SMITH, LLP, 4 RESEARCH DRIVE, SHELTON, CT, 06484-6212, US

(73) Assignee: Nokia Corporation, Espoo (FI)

(21) Appl. No.: 10/722,965

(22) Filed: Nov. 26, 2003

(51) Int. Cl. H04Q 7/00

(52) U.S. Cl. 455/456.3

(57) ABSTRACT

A method is disclosed to operate a wireless network (20) with a MS (100) and includes, registering the MS with a correspondent node CN (99); sending data from the CN to a Content Proxy Server (95) identified by the MS; and determining a current location of the MS with the Content Proxy Server, setting up a Point to Point Protocol PPP between the MS at its current location and the wireless network, and routing the data from the Content Proxy Server to the MS at its current location. Registering includes sending a Network Access Identifier NAI of the MS and an Internet Protocol IP address of the Content Proxy Server to the CN from the MS, where the data sent from the CN to the Content Proxy Server includes the NAI, and where the Content Proxy Server determines the current location of the MS by sending a query to a home Authentication, Authorization and Accounting AAA server (80), the query comprising the NAI.

### TECHNICAL FIELD

This invention relates generally to packet data communications systems having mobile nodes and, more specifically, relates to techniques for routing data packets to a mobile node during a network initiated data session.

### BACKGROUND

The following abbreviations are herewith defined for the purposes of this patent application:
3GPP Third Generation Partnership Project
AAA Authentication, Authorization and Accounting
BSC Base Station Controller
BS Base Station
BTS Base Transceiver Station
CDMA Code Division, Multiple Access
CN Correspondent Node
CS Circuit Switched
GRE Generic Routing Encapsulation
HA Home Agent
HLR Home Location Register
IETF Internet Engineering Task Force
IMSI International Mobile Subscriber Identity
IP Internet protocol
IWF Inter-Working Function
LDAP Lightweight Directory Access Protocol
MIN Mobile Identity Number
MIP Mobile Internet Protocol
MMS Multimedia Messaging Service
MN Mobile Node
MS Mobile Station
MSC Mobile Switching Center
NAI Network Access Identifier
NIDS Network Initiated Data Session
PCF Packet Control Function
PDSN Packet Data Serving Node
PPP Point to Point Protocol
PS Packet Switched
PZID Packet Zone ID
RADIUS Remote Authentication Dial-In User Service
RN Radio Network
RP Radio Protocol
SDU Service Data Unit
SPZ Sub-Paging Zone
SPZ_ID Sub-Paging Zone Identifier
SQL Structured Query Language
VLR Visitor Location Register

FIGS. 1A and 1B illustrates major functional components and the interfaces of a conventional wireless network 20 suitable for operation with a MN or MS 100. Beginning with FIG. 1A, a source BS 45 includes a BSC 40 and a plurality of BTSs 50. The BSC 40 includes a SDU function that operates to identify the information transferred between peer layer entities which is not interpreted by supporting lower layer entities. On the voice side the BS 45 is coupled to a MSC 60, more specifically it is coupled via an A1 interface (both CS and PS services) to a MSC call control and management function 60A and via A2 and A5 interfaces (CS services only) to a MSC switch 60B. The MSC 60 is shown coupled to an IWF 61. The BS 45 may also be coupled via interfaces A3 (user traffic), A3 and A7 (signalling) to a target BS 45′, containing an associated BSC 40′ and BTSs 50′. On the data side the BS 45 is coupled to a PCF 30 via interfaces A8 (user traffic) and A9 (signalling). The PCF 30 is a component of the radio access network that controls the transmission of packets between the BS 45 and a PDSN 32. The PDSN 32 is responsible for the establishment, maintenance and termination of a PPP session towards the MN. It may also assign dynamic IP addresses in addition to supporting Mobile IP functionality. It provides a similar function to the GSN (GPRS Support Nodes) found in the GSM and UMTS networks. The interfaces between the PCF 30 and the PDSN 32 are designated A10 (user traffic) and A11 (signalling), and include GRE and R-P sign capability.

FIG. 1B illustrates further aspects of the wireless network 20. For example, the MSC 60 is shown connected via an IS-41 MAP interface to a VLR 62, which in turn is coupled via the IS-41 MAP to a SS-7 (signalling system seven) network and thence to a HLR 64. The PDSN 32 is coupled to an IP network 70, and through the IP network 70 to a home AAA 80 and to a HA 90 (e.g., a home IP network a home access provider network, or a private network). The AAA 80 is generally a function that is used to identify a user and the user's privileges, and to record and track that user's activities. The PDSN 32 can also be coupled to a visited AAA 80′, and to one or more broker AAAs 81. Note that the target BS 45 associated with a target RN is shown to also include a PCF 30′ and a PDSN 32′, also coupled to the IP network 70.

Those skilled in the art should appreciate that the foregoing description of the wireless network 20 shown in FIGS. 1A and 1B is not intended to be an exhaustive study of wireless networks, but has been provided simply to place the ensuing discussion and description of this invention into a technological context and framework.

In order to provide an “Always On Service” the network 20 is required to push data to the MS 100. However, the CDMA network architecture as currently defined by 3GPP-2 does not include a capability for the wireless network 20 to push data to a MS 100 that is on an Idle state or mode. If the MS 100 is instead in the Active state, the PDSN 32 has knowledge of the location of the Ms 100 because of the RP session with the PCF 30.

However, for a MS 100 in the Idle state there is no corresponding RP session. A data session needs to be initiated by the MS 10-0 and, at present, there is no defined way for the network 20 to initiate the session set up. As such, it can be appreciated that one of the problems that arise in a network-initiated session set up is to locate the MS 100 in the network 20.

On the voice side of the network the MSC/HLR 60, 64 have exact location information for the MS 100. Thus, when a mobile terminated voice call needs to be delivered the HLR 64 is contacted to obtain the current location information, and the MS 100 is then paged efficiently by the correct group of BTSs 50. On the data side, however, the packet core network elements have data that needs to be pushed to the MS 100, but there is no interface to the HLR 64 (as can be seen in FIG. 1B). Also, in order to deliver the packet data the correct PDSN 32, PCF 30 and BSC 40 combination should be selected so that the page messages can be sent out efficiently.

It can be noted that even if there were an interface to the HLR 64 from the packet core network elements, the HLR 64 does not have the MS 100 location information in terms of the correct PCF 30 and PDSN 32 combination.

There has been a proposal to address this problem between the PCF 30 and the BSC 40 (using the A8 and A9 interfaces). Reference in this regard can be made to a document: 3GPP2 cdma2000 TSG-C, entitled “Mobile paging with mobile station sub-paging zone update”, Ke-Chi Jang et al. (Nortel Networks, 2003, C23-20030714-038R3). This document proposes an efficient way to enable a BS 45 to page a MS 100 in a smaller area. It is said that a registration zone is adequate for voice services, but for packet data service the BS 45 may need to track the MS 100 to a smaller sub-paging zone to achieve a more efficient dormant to active transition. To improve the paging with a smaller SPZ, it was proposed to broadcast a SPZ_ID in an overhead message. The MS 100 that supports this feature reports its location on the R-CSCH (Reverse Common Signaling Logical Channel, a logical channel that carries higher layer signaling traffic from the MS to the BS over a common physical channel) when it detects a SPZ change. The service provider configures the size of the SPZ, and all BSs 45 in the same SPZ have the same zone value. Based on the report from the MS 100, a network 20 with BSC 40 level control can page the MS 100 within the zone where the MS 100 sends the location report over the R-CSCH. FIG. 2, based on a figure in the C23-20030714-038R3 document, shows the various possible scenarios.

One of the problems encountered in NIDS is routing the data packets from a CN to the MS 100. If the CN, which is providing the push service, uses an IP address to route the packets, there is no guarantee that the IP address used can be mapped to the correct MS 100 as the MS 100 may be using a dynamic IP address. Also, even if the MS 100 is using a static IP address, it is possible that the MS 100 has moved, but is still in the Idle state. Therefore, the MS 100 does not yet have a mobile IP association with the HA 90.

A related problem is that the network is required to waste IP addresses by reserving them for the MS, even though the MS does not have an open session with the network.

It has been proposed to use the IP address associated with the MS 100 to route the packets. Reference in this regard can be made to a document: 3GPP2 TSG-S Meeting in San Diego, Calif., entitled “Additional Information on Network Initiated Data Sessions”, J. Jayapalan et al. (Motorola, Inc., 2003, S10-20030512-007). This proposal provides a Stage 2 call flow example of the use of NIDS for a Mobile IP call. In the example it is assumed that the mobile either has a fixed IP address, or was previously assigned an IP address from its initial session establishment and has gone idle, and that the Home Agent (HA 90) is able to associate the target IP address to the correct PDSN.

This conventional call flow example proceeds as follows:
1. Upon receipt of IP packets for an idle MS, the HA forwards the packets to the PDSN associated with the MS. The PDSN does not have an active session for the MS, but has context information for the target IP address. The PDSN selects the appropriate PCF and requests a data connection for the MIN (mobile identification number) saved in context.
2. Upon receipt of a Reconnect Request from the PDSN, the PCF and BS initiate idle to active transition processing.
3. The BS then initiates a service request to the MSC/HLR to generate the mobile page process.
4. The MS responds to the page and the traffic channel is (re) established.
5. The PDSN does not have an active session and (re)initiates the PPP session.

It can be appreciated that this proposal does not solve the problems noted above, and thus an unfulfilled need still exists to enable the data side of the network 20 to efficiently route data packets to the MS 100 in the NIDS mode.

### SUMMARY OF THE PREFERRED EMBODIMENTS

The foregoing and other problems are overcome, and other advantages are realized, in accordance with the presently preferred embodiments of these teachings.

In order to solve the problem of effectively routing the data to the correct MS this invention uses the NAI as the information for routing the packets to the MS. A new entity in the home service network, referred to as a Content Proxy Server, is defined.

When a mobile user subscribes to a service or services offered by a CN in the public network, it sends the NAI and the address of the Content Proxy Server. This can be done by using existing HTTP extension fields. The CN saves this information and later, when the it has data to send to the MS, it sends the data to the Content Proxy server in an HTTP session. The NAI of the user is included as part of the HTTP extension. The Content Proxy Server queries the profile of the user by sending a query to the home AAA server, indicating the NAI in question. Based on the response from the AAA server, the Content Proxy Server forwards the data packets to the HA, or to the home PDSN or visited PDSN.

The invention thus solves the problem of routing packets to a MS that does not have a data session, and thus an associated IP address.

This invention provides the capability to extend the network initiated data session feature for a MS that does not have a static IP address. The invention also overcomes the problem where the network has to waste IP addresses by reserving them for the MS, even though the MS does not have an open session with the network.

Disclosed is a method to operate a wireless network with a mobile station MS, as well as a wireless network and MS operate in accordance with the method. The method includes registering the MS with a correspondent node CN; sending data from the CN to a Content Proxy Server identified by the MS; and determining a current location of the MS with the Content Proxy Server, setting up a Point to Point Protocol PPP between the MS at its current location and the wireless network, and routing the data from the Content Proxy Server to the MS at its current location. Registering includes sending a Network Access Identifier NAI of the MS and an Internet Protocol IP address of the Content Proxy Server to the CN from the MS, where the data sent from the CN to the Content Proxy Server includes the NAI, and where the Content Proxy Server determines the current location of the MS by sending a query to a home Authentication, Authorization and Accounting AAA server, the query comprising the NAI.

A Content Proxy Server is also disclosed. The Content Proxy Server has a network address, a network interface and a controller coupled to the network interface for receiving and storing data intended for a MS from a CN. The Content Proxy Server operates to determine a current location of the MS and to initiate a Network Initiated Data Session NIDS for the MS at its current location. In the preferred embodiment the controller determines the current location of the MS by issuing a query to the AAA server.

In accordance with a further aspect of this invention there is a method and system to operate a wireless network with a MS. The method includes registering the MS with the CN; sending data from the CN to the Content Proxy Server identified by the MS; determining a current location of the MS with the Content Proxy Server; and initiating a Network Initiated Data Session NIDS for the MS at its current location. In response to the MS obtaining an IP address, in one embodiment the method routes data from the Content Proxy Server to the MS at its current location, and in another embodiment the MS re-registers with the CN, which sends the data to the MS at its current location.

Also disclosed is a MS operable in a wireless network that comprises a BS. The MS comprises a transmitter for sending a registration request via the BS to a CN. The wireless network further comprises or is otherwise coupled to a Content Proxy Server. The CN sends data to the Content Proxy Server that is identified by the MS when sending the registration request to the CN. The Content Proxy Server operates to determine a current location of the MS and to initiate a Network Initiated Data Session NIDS for the MS at its current location. The MS also has a receiver to receive data sourced by the CN, via the BS, at its current location.

Also disclosed is a BS operable in a wireless network that comprises a MS. The BS comprises a receiver for receiving a registration request from the MS for a CN. The wireless network further comprises or is otherwise coupled to a Content Proxy Server. The CN sends data to the Content Proxy Server that is identified by the MS when sending the registration request to the CN. The Content Proxy Server operates to determine a current location of the MS and to initiate a Network Initiated Data Session NIDS for the MS at its current location. The BS further includes a transmitter to transmit data sourced by the CN to the MS at its current location.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIGS. 1A and 1B are block diagrams that illustrate conventional wireless network functional components and the interfaces between them;

FIG. 2 is a diagram from the prior art that shows various zones associated with two BSCs and one MSC;

FIG. 3 is a block diagram of a MS coupled the wireless network, and illustrates one suitable embodiment of apparatus for practicing this invention;

FIG. 4 is a signalling diagram that illustrates the operation of the MS and the wireless network for storing MS location-related information at the AAA;

FIG. 5 is a signalling diagram that illustrates a presently preferred subscription process; and

FIG. 6 is a signalling diagram that illustrates a presently preferred technique for delivering data packets to the MS from the CN.

### DETAILED DESCRIPTION OF THE PREFERRED EMBODIMENTS

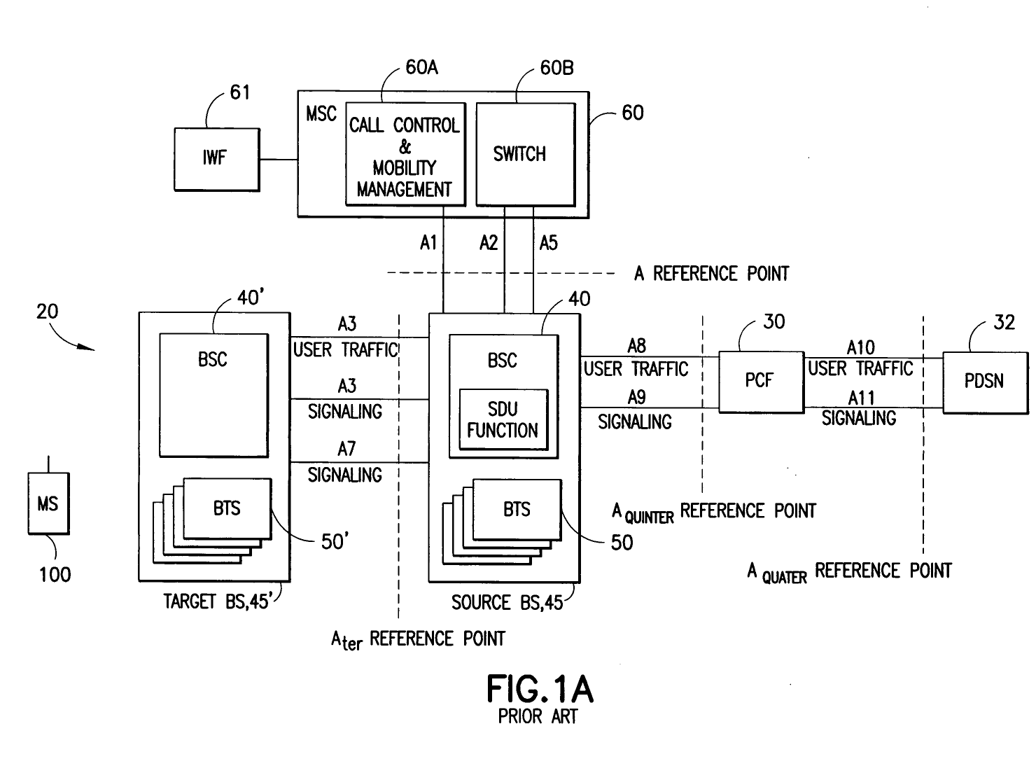

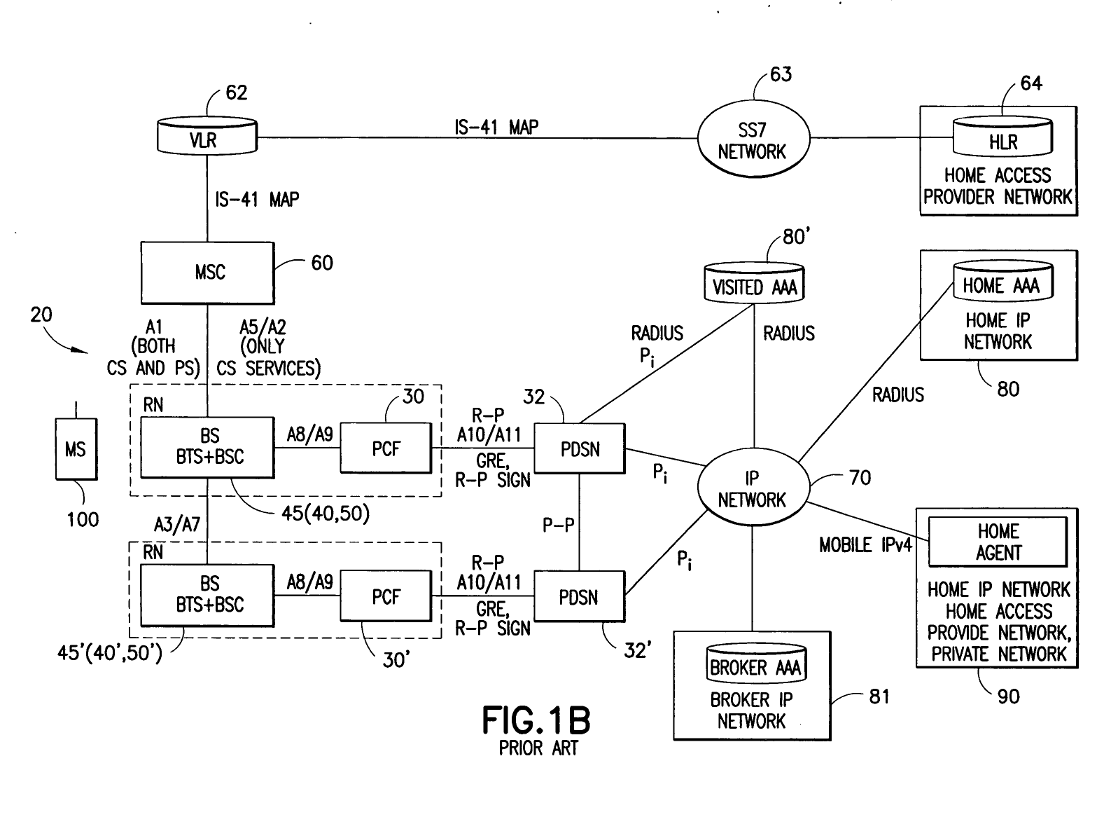

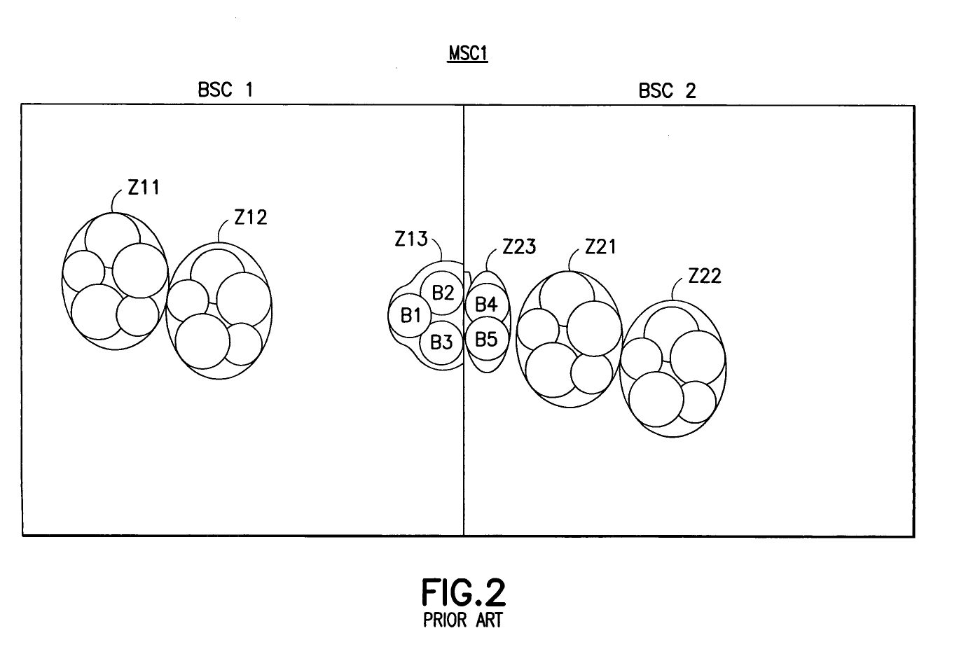

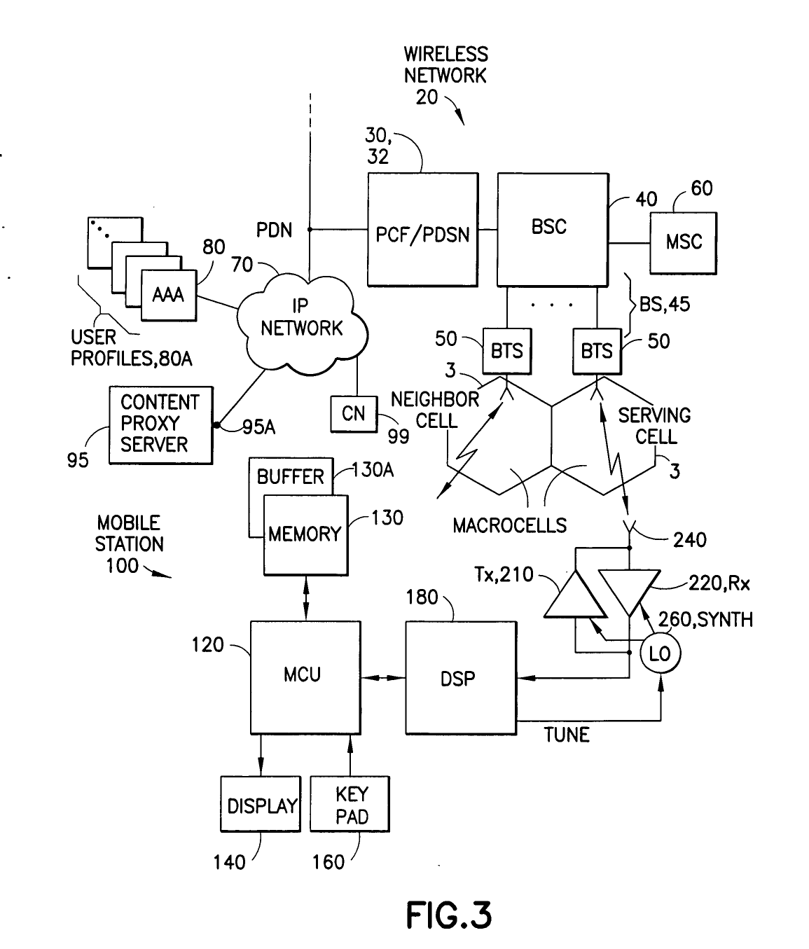

By way of introduction, and referring to FIG. 3, there is shown as a simplified block diagram an embodiment of a wireless communications system that is suitable for practicing this invention. The wireless communications system includes at least one MS 100. FIG. 3 also shows an exemplary wireless network 20 having, for example, a PCF/PDSN 30, 32 depicted for simplicity as a single node for connecting to a Packet Data Network (PDN) and thence to an IP network 70, such as the Internet. The wireless network 20 also includes at least one BS 45 containing a BSC 40 or equivalent apparatus, and a plurality of BTSs 50, that transmit in a forward or downlink direction both physical and logical channels to the MS 100 in accordance with a predetermined air interface standard. A reverse or uplink communication path also exists from the MS 100 to the network 20, which conveys MS-originated access requests and traffic. A cell 3 is associated with each BTS 50, where one cell will at any given time be considered to be a serving cell, while an adjacent cell(s) will be considered to be a neighbor cell. Smaller cells (e.g., picocells) may also be available. Also shown is the MSC 60 on the voice side of the network 20, and an AAA server 80 on the data side. The AAA server 80 is assumed to store a plurality of user profiles 80A corresponding to individual users of the network 20. It should be appreciated that the wireless network 20 may be constructed as shown in FIGS. 1A and 1B, and may thus contain the same interfaces and other, non-illustrated components. Also coupled to the IP network 70, in accordance with an aspect of this invention, is a Content Proxy Server 95. It is also assumed that there is at least one CN 99 coupled to the IP network 70.

The air interface standard can conform to any suitable standard or protocol, and may enable both voice and data traffic, such as data traffic enabling Internet 70 access and web page downloads. The air interface standard may compatible with a 3GPP2-compatible standard, or a code division multiple access (CDMA) air interface standard, such as one known as cdma2000, although this is not a limitation upon the practice of this invention. For example, this invention could be employed in a CDMA 2000-802.11 (WLAN) interworking scenario.

The MS 100 typically includes a control unit or control logic, such as a microcontrol unit (MCU) 120 having an output coupled to an input of a display 140 and an input coupled to an output of a keyboard or keypad 160. The MS 100 may be a handheld radiotelephone, such as a cellular telephone or a personal communicator. The MS 100 could also be contained within a card or module that is connected during use to another device. For example, the MS 100 could be contained within a PCMCIA or similar type of card or module that is installed during use within a portable data processor, such as a laptop or notebook computer, or even a computer that is wearable by the user.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, received zone ID information, and the like. At least some of this temporary data can be stored in a buffer 130A. The operating program is assumed, for the purposes of this invention, to enable the MCU 120 to execute the software routines, layers and protocols required to implement the methods in accordance with this invention, as well as to provide a suitable user interface (UI), via display 140 and keypad 160, with a user. Although not shown, a microphone and speaker are typically provided for enabling the user to conduct voice calls in a conventional manner, via the BS 45 and the MSC 60.

The MS 100 also contains a wireless section that includes a digital signal processor (DSP) 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized voice and packet data, as well as signalling messages are transmitted and received through the antenna 240.

As will be made evident below, this invention can employ a technique described in commonly assigned U.S. patent application Ser. No.: ______, filed on even date herewith, and entitled “Method and Apparatus to Provide Efficient Paging for a Network Initiated Data Session”, by Sarvesh Asthana (Attorney Docket No.: NC34708/871.0117.U1(US)). Before described the present invention in further detail, a review is herewith made of the invention described in this commonly assigned U.S. Patent Application.

In accordance with the invention disclosed in the commonly assigned U.S. Patent Application it becomes possible, from the data side of the network 20, to locate the MS 100 by a combination of BTS 50, BSC 40, PCF 30 and PDSN 32. For convenience this technique employs the already-defined identifiers for a BTS 50, or a group of BTSs 50, and the controlling BSC 40, that were referred to above as the SPZ_ID, and for the PCF 30 the already defined PZID (see, again, the above-referenced C23-20030714-038R3 document). In order to identify the position of the MS 100 in the network 20 across the PDSNs (30, 32′) the IP address of the pertinent one of the PDSNs is used as the identifier for the PDSN 32.

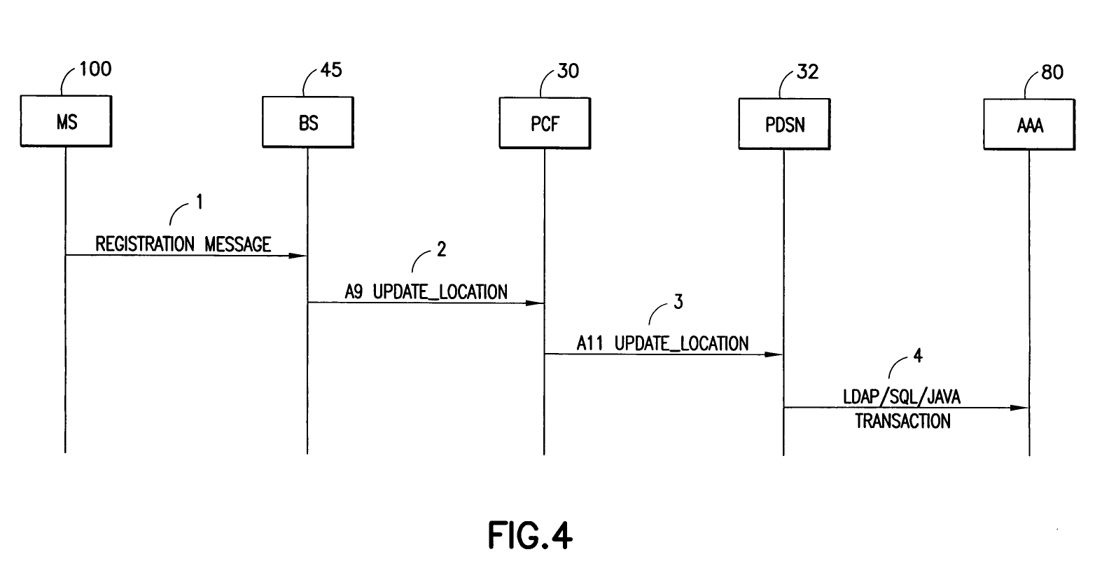

With regard to the invention in the commonly assigned U.S. Patent Application, a description is now made of a registration procedure on the data side of the network 20. Reference is also made to FIG. 4.

Step 1: The MS 100 sends a Registration message to the BS 45. The sending of the Registration message is triggered by the MS 100 moving to a different SPZ_ID zone and/or a different PZID, as detected by the MS 100 from the downlink message that is broadcast to include the SPZ_ID. The Registration message includes the SPZ_ID received by the MS 100 in the received downlink message that triggered the sending of the Registration message, since it differed from a previous SPZ_ID stored in the buffer memory 130A of the MS 100. In the preferred embodiment of this invention the Registration message is sent when the MS 100 is in the Idle state.

Step 2: The BS 45 sends an A9-Update_Location message to the PCF 30. The A9-Update_Location message includes the IMSI of the MS 100 and the SPZ_ID reported by the MS 100 in the Registration message.

Step 3: The PCF 30 selects a PDSN 32 based on a suitable PDSN 32 selection algorithm and forwards the location information to the selected PDSN 32 in an A11 Update_Location message. This message includes the IMSI, SPZ_ID and PZID information for the MS 100.

Step 4: The PDSN 32 updates a user profile (UP 80A) stored in the AAA server 80 to reflect the current SPZ_ID, PZID by using a LDAP interface, or a JAVA/SQL interface to the AAA server 80 (JAVA™ is a Trademark of Sun Microsystems, Inc.) LDAP defines a standard for defining a hierarchical directory structure, and a standard interface for accessing these directories. LDAP originated from the X.500 standard. A protocol such as LDAP can be used to access an X.500 directory. It is also within the scope of this invention to use a modified RADIUS interface that includes change information to be sent asynchronously to the AAA server 80.

The AAA server 80, if this is the home AAA server 80 for the MS 100 stores the SPZ_ID, PZID and the PDSN IP address for indicating the current location of the MS 100. If the AAA server is not the home AAA server 80, i.e., it is a visited AAA server 80′, it forwards the SPZ_ID, PZID and the PDSN IP address information, along with the and identity of the MS 100 (e.g., the IMSI) to the home AAA server 80 possibly through one or more broker AAA servers 81 (see FIG. 1B).

As was noted above, in order to solve the problem of effectively routing the data to the correct MS 100 the present invention employs the NAI as information for routing the packets to the MS 100. The new entity in the home service network, referred to as the Content Proxy Server 95, is also defined.

In general, the NAI is used to address a user within a specific Internet domain. The format of the NAI is similar to that of an email address, as it contains a user portion that identifies the individual node and a realm portion that identifies an administrative domain within the Internet. The two portions are separated by an @ sign. The NAI is used for access/accounting in CDMA wireless networks, and usually takes the form of “user@realm”, “user@domain.com” or “MIN@domain.com”. Reference can be made to IS83 3GPP2 for further details related to the use of the NAI. The use of the NAI is preferred as the IMSI is more proprietary to service providers.

Described now in further detail is a procedure for setting up a subscription for a NIDS application with a CN 99, and the routing of packets to a correct PDSN 32 for setting up a PPP session with the MS 100 so that the data from the CN 99 can be delivered to the MS 100.

The service is setup between the MS 100 and a CN 99 that is advertising a push kind of service in the Internet 70. It is assumed that once the subscription has been setup the CN 99 will periodically send (push) the relevant data to the MS 100. Stock quotes, weather forecasts and traffic reports are all non-limiting examples of data that can be pushed to the MS 100 from a CN 99.

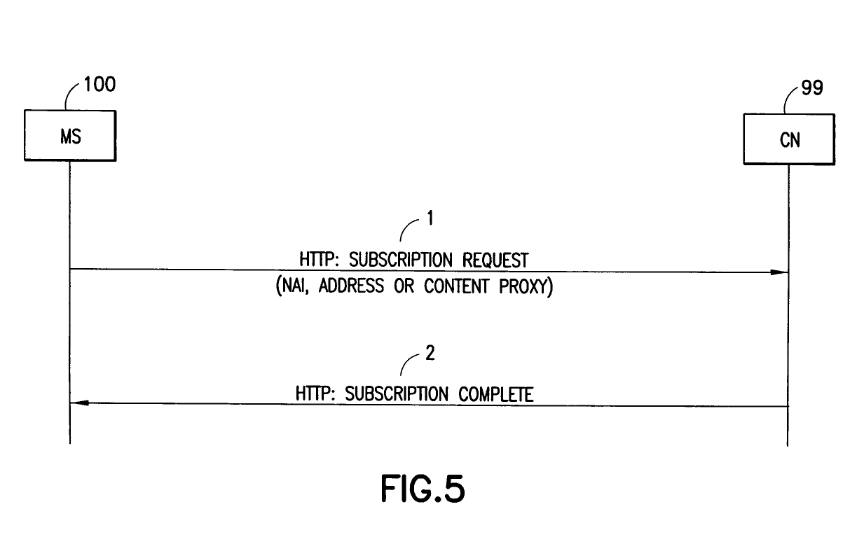

FIG. 5 shows network signalling diagram that involves the Content Proxy Server 95 that is used as a gateway between the MS 100 and the CN 99. It is assumed that the MS 100 had a fixed or dynamic IP address when it decides to subscribe to the service provided by the CN 99.

Step 1: The MS 100 sends the subscription request including the NAI of the MS 100 and the address of the Content Proxy Server 95 in the home network. The address of the Content Proxy Server 95 can be provisioned into the MS 100 by direct programming or by over the air programming, or it can be discovered by the MS 100.

Step 2: The CN 99 saves the NAI of the MS 100 and the address of the Content Proxy Server 95 with the other subscription information, and sends a subscription complete message back to the MS 100. At this time the subscription process is complete.

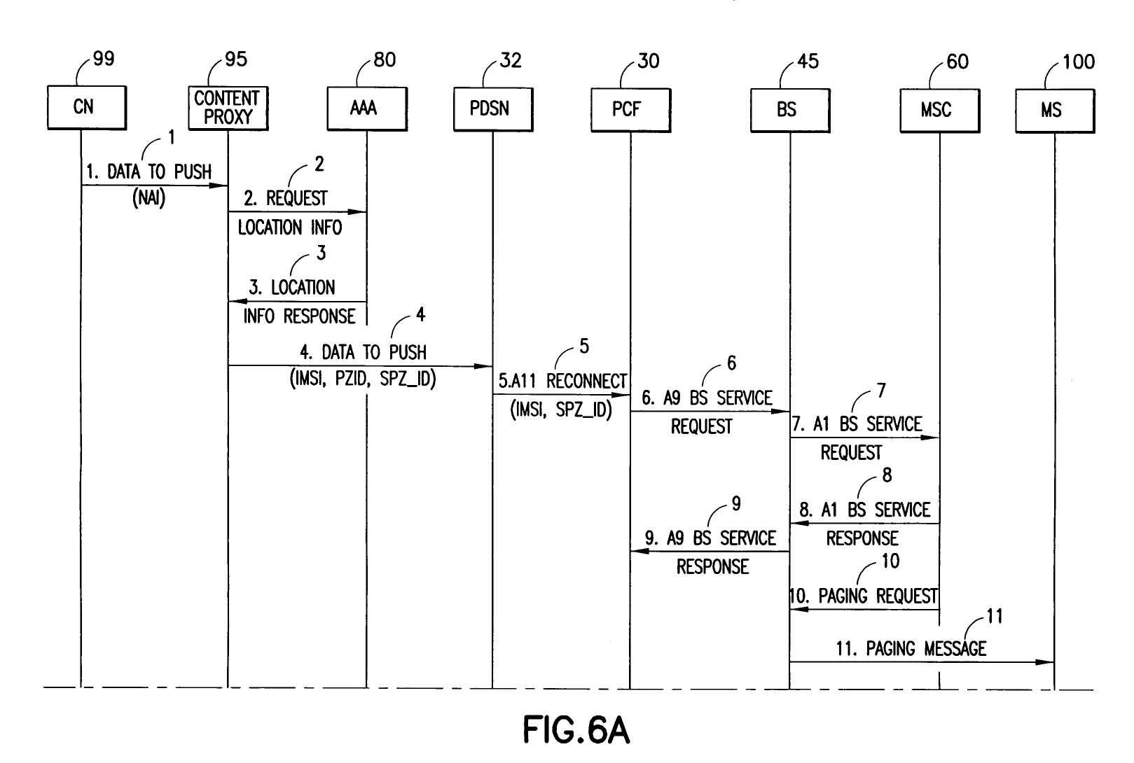

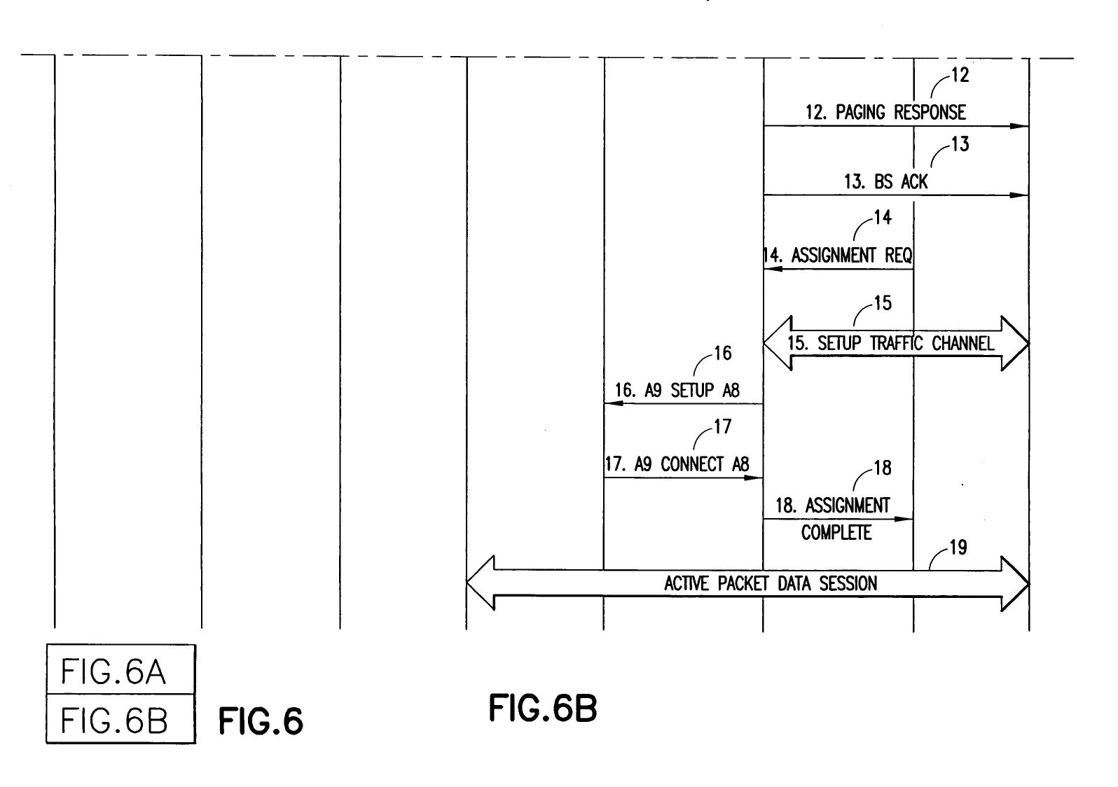

Referring now to FIG. 6, it is assumed that the MS 100 goes back to the Idle state, and has no PPP session with any of the PDSN's 32 in the network 20. FIG. 6 shows the routing of the data packet(s) form the CN 99 to the MS 100.

Step 1: The CN 99 sends data to the Content Proxy Server 95. The data includes the NAI of the MS 100 as an HTTP extension. As an example, a HTTP extension framework is defined in RFC 2774. It is believed that MMS currently uses HTTP extensions to communicate NAI/IMSI information.

Step 2: The Content Proxy Server 95 uses the LDAP/SQL/JAVA interface into the AAA server 80 to query the location information of the MS 100. In this embodiment the location information that is queried is that provided to the AAA server 80 in accordance with FIG. 4 and the invention described in the above-captioned commonly assigned U.S. patent application Ser. No.: ______, filed on even date herewith, and entitled “Method and Apparatus to Provide Efficient Paging for a Network Initiated Data Session”, by Sarvesh Asthana (Attorney Docket No.: NC34708/871.0117.U1(US)). The Content Proxy Server 95 gives the NAI of the MS 100 in the query to the AAA server 80.

Step 3: The AAA server returns the MS 100 location information as a location tuple in terms of the current PDSN IP address, current PZID and current SPZ_ID. It may also indicate if the MS 100 has a static IP address, as well as the IMSI of the MS 100.

Step 4: The Content Proxy Server 95 forwards the data to the current PDSN 32 reported in the location tuple by the AAA server 80. It should be noted that if the MS 100 has a static IP address that the Content Proxy Server 95 preferably forwards the data first to the HA 90, with the IMSI, PDSN, SPZ_ID and PZID information. In this case the HA 90 checks to determine if there is a mobile IP association for the MS 100, and if there is the HA 90 forwards the data to that PDSN 32 (e.g., to PDSN 32′), otherwise it forwards the data to the PDSN 32 reported in the location information.

With regard to this Step 4, it is noted that at this time there is not an actual existing context between the Content Proxy Server 95 and the PDSN 32 or HA 90 for forwarding these messages. There are, however, several solutions to this problem. For example, in a first solution the Content Proxy Server 95 saves or caches the messages received from the CN 99, and may then send a proprietary message to the PDSN 32 or HA 90 to initiate the NIDS. Once the MS 100 obtains an IP address as a result of the call setup it contacts the Content Proxy Server 95 to retrieve the cached messages. In a second solution the Content Proxy Server 95 receives the message(s) from the CN 99 and initiates the NIDS setup by sending a proprietary message to the PDSN 32 or the HA 90. Once the NIDS completes and the MS 100 has an IP address, it re-subscribes with the CN 99 and the CN 99 then sends the data directly to the MS 100.

Step 5: The PDSN 32 is assumed to detect that it does not have a PPP associated with the IMSI of the MS 100. In response, it sends an A11 Reconnect message to the PCF 30 identified by the PZID. This message includes the IMSI and the SPZ_ID indicating the current position of the MS 100.

Step 6: The PCF 30 sends an A9 BS Service Request to the BS 45 identified by the SPZ_ID.

Step 7: The BS 45 sends an A1 BS Service Request message to the MSC 60.

Steps 8-18: The MS 100 and the BS 45 set-up the traffic channel, using conventional protocols and procedures, and the MSC 60 and the PCF 30 are notified of the successful setup.

Step 19: As there is no PPP session, the PDSN 32 and the MS 100 set-up the PPP. This process may involve a MIP registration process as well. The Mobile Internet Protocol provides a set of extensions to the Internet protocol standards defined by the IETF. The focus of MIP is to permit a user to register on Foreign networks and connect back to their Home network via a combination of FA (Foreign Agent) and HA (Home Agent 90).

Once the PPP is setup, the PDSN 32 forwards the data over the PPP link to the MS 100 during an Active Packet Session, shown generally as Step 19.

Based on the foregoing description it can be appreciated that an aspect of this invention is the Content Proxy Server 95. The Content Proxy Server 95 is assumed to have a network address, a network interface 95A and a controller, or more generally a control function, that is coupled to the network interface for receiving and storing data packets intended for MS 100 from the CN 99. The Content Proxy Server 95 operates to determine a current location of the MS 100 and to initiate setting up the PPP between the MS 100 and the wireless network 20, at the current location of the MS 100, so as to send the data from the Content Proxy Server 95 to the MS 100 at its current location. In the presently preferred, but non-limiting embodiment, the controller determines the current location of the MS 100 by issuing the query to the AAA server 80. The foregoing description has provided by way of exemplary and non-limiting examples a full and informative description of the best method and apparatus presently contemplated by the inventor for carrying out the invention. However, various modifications and adaptations may become apparent to those skilled in the relevant arts in view of the foregoing description, when read in conjunction with the accompanying drawings and the appended claims. As but some examples, the use of other similar or equivalent messages and message data elements may be attempted by those skilled in the art. Further, the various functional units and interfaces shown in FIGS. 1A, 1B and 3 may be supplemented or some may be removed, and the various units, functions and interfaces may be referred to by different names. Furthermore, this invention does not require the use of the MS 100 location determination and registration process disclosed in the above referenced commonly-assigned U.S. Patent Application, as other techniques to identify the location of the MS 100 may be employed, and the MS 100 location may be stored or recorded at some location other than the AAA server 80. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A method to operate a wireless network with a mobile station MS, comprising:
registering the MS with a correspondent node CN;
sending data from the CN to a Content Proxy Server identified by the MS; and
determining a current location of the MS with the Content Proxy Server, setting up a Point to Point Protocol PPP between the MS at its current location and the wireless network, and routing the data from the Content Proxy Server to the MS at its current location.

2. A method as in claim 1, where registering comprises sending a Network Access Identifier NAI of the MS and an Internet Protocol IP address of the Content Proxy Server to the CN from the MS, where the data sent from the CN to the Content Proxy Server includes the NAI, and where the Content Proxy Server determines the current location of the MS by sending a query to a home Authentication, Authorization and Accounting AAA server, the query comprising the NAI.

3. A method as in claim 1, further comprising, in response to detecting that the MS has changed its location in the wireless network, registering the MS with a base station BS to indicate the current location of the MS; and in response to the MS registering with the BS, triggering the sending of messages in the wireless network until information that is indicative of the current location of the MS is recorded by an Authentication, Authorization and Accounting AAA server, where the Content Proxy Server determines the current location of the MS by sending a query to the AAA server.

4. A method as in claim 1, further comprising, in response to detecting that the MS has changed its location in the wireless network, and that the MS is in an Idle state, sending a message from the MS to a base station BS, the message indicating the current location of the MS; and triggering the sending of further messages in the wireless network from the BS to a Packet Control Function PCF, and from the PCF to a Packet Data Serving Node PDSN, and from the PDSN to an Authentication, Authorization and Accounting AAA server such that information that is indicative of a current BS/PCF/PDSN affiliation of the MS at the current location of the MS is recorded by the AAA server, where the Content Proxy Server determines the current location of the MS by sending a query to the AAA server.

5. A method as in claim 4, where the MS is identified at least in part by its International Mobile Subscriber Identity IMSI, and where the PDSN is identified by its Internet Protocol IP address.

6. A method as in claim 3, where detecting comprises receiving a sub-paging zone identifier with the MS, comparing the received sub-paging zone identifier with a previously received sub-paging zone identifier, and detecting that the MS has changed its location in the wireless network when the received sub-paging zone identifier does not match with the previously received sub-paging zone identifier.

7. A method as in claim 3, where the information comprises a sub-paging zone identifier SPZ_ID, a paging zone identifier PZID, and an Internet Protocol IP address of the PDSN.

8. A method as in claim 7, where querying the AAA server is performed in response to an occurrence of a network initiated data session NIDS for the MS, and where the AAA server returns at least the SPZ_ID, PZID and PDSN IP Address that are recorded for the MS.

9. A method as in claim 4, where detecting comprises receiving a sub-paging zone identifier with the MS, comparing the received sub-paging zone identifier with a previously received sub-paging zone identifier, and detecting that the MS has changed its location in the wireless network when the received sub-paging zone identifier does not match with the previously received sub-paging zone identifier.

10. A method as in claim 4, where the information comprises a sub-paging zone identifier SPZ_ID, a paging zone identifier PZID, and an Internet Protocol IP address of a Packet Data Serving Node PDSN.

11. A method as in claim 10, where querying the AAA server is performed in response to an occurrence of a network initiated data session NIDS for the MS, and where the AAA server returns at least the SPZ_ID, PZID and PDSN IP Address that are recorded for the MS.

12. A wireless network comprising a mobile station MS operable for registering the MS with a correspondent node CN, said wireless network coupled to a Content Proxy Server, said CN sending data to said Content Proxy Server that is identified by the MS when registering with the CN, said Content Proxy Server operating to determine a current location of the MS and to initiate setting up a Point to Point Protocol PPP between the MS and the wireless network at its current location and to route the data from the Content Proxy Server to the MS at its current location.

13. A wireless network as in claim 12, where registering comprises sending a Network Access Identifier NAI of the MS and an Internet Protocol IP address of the Content Proxy Server to the CN from the MS, where the data sent from the CN to the Content Proxy Server includes the NAI, and where the Content Proxy Server determines the current location of the MS by sending a query to a home Authentication, Authorization and Accounting AAA server, the query comprising the NAI.

14. A wireless network as in claim 112, where said MS is further responsive to detecting that the MS has changed its location in the wireless network to register said MS with a base station BS to indicate the current location of said MS; and said wireless network, in response to the MS registering with the BS, triggering the sending of messages in the wireless network until information that is indicative of the current location of the MS is recorded by an Authentication, Authorization and Accounting AAA server, where the Content Proxy Server determines the current location of the MS by sending a query to the AAA server.

15. A wireless network as in claim 12, where said MS is further responsive to detecting that the MS has changed its location in the wireless network, and that the MS is in an Idle state, to send a message to a base station BS, the message indicating the current location of said MS; and said wireless network, in response to the MS registering with the BS, triggering the sending of further messages in the wireless network from the BS to a Packet Control Function PCF, and from the PCF to a Packet Data Serving Node PDSN, and from the PDSN to an Authentication, Authorization and Accounting AAA server such that information that is indicative of a current BS/PCF/PDSN affiliation of the MS at the current location of the MS is recorded by the AAA server, where the Content Proxy Server determines the current location of the MS by sending a query to the AAA server.

16. A wireless network as in claim 15, where the MS is identified at least in part by its International Mobile Subscriber Identity IMSI, and where the PDSN is identified by its Internet Protocol IP address.

17. A wireless network as in claim 14, where said MS detects that the MS has changed its location in the wireless network by receiving a sub-paging zone identifier with the MS, comparing the received sub-paging zone identifier with a previously received sub-paging zone identifier, and detecting that the MS has changed its location in the wireless network when the received sub-paging zone identifier does not match with the previously received sub-paging zone identifier.

18. A wireless network as in claim 14, where the information comprises a sub-paging zone identifier SPZ_ID, a paging zone identifier PZID, and an Internet Protocol IP address of the PDSN.

19. A wireless network as in claim 18, where said AAA server is queried in response to an occurrence of a network initiated data session NIDS for the MS, and where said AAA server returns at least the SPZ_ID, PZID and PDSN IP Address that are recorded for the MS.

20. A wireless network as in claim 15, where said MS detects that the MS has changed its location in the wireless network by receiving a sub-paging zone identifier with the MS, comparing the received sub-paging zone identifier with a previously received sub-paging zone identifier, and detecting that the MS has changed its location in the wireless network when the received sub-paging zone identifier does not match with the previously received sub-paging zone identifier.

21. A wireless network as in claim 15, where the information comprises a sub-paging zone identifier SPZ_ID, a paging zone identifier PZID, and an Internet Protocol IP address of a Packet Data Serving Node PDSN.

22. A wireless network as in claim 21, where said AAA server is queried in response to an occurrence of a network initiated data session NIDS for the MS, and where the AAA server returns at least the SPZ_ID, PZID and PDSN IP Address that are recorded for the MS.

23. A Content Proxy Server having a network address and comprising a network interface, said Content Proxy Server further comprising a controller coupled to said network interface for receiving and storing data intended for a mobile station MS from a correspondent node CN, said Content Proxy Server operating to determine a current location of the MS and to initiate a Network Initiated Data Session NIDS for the MS at its current location.

24. A Content Proxy Server as in claim 23, where said controller determines the current location of the MS by issuing a query to an Authentication, Authorization and Accounting AAA server.

25. A Content Proxy Server as in claim 24, where said controller issues the query over a LDAP/SQL/JAVA interface to the AAA server.

26. A Content Proxy Server as in claim 24, where said controller receives a response to the query from the AAA server as a location tuple comprising a current Packet Data Serving Node PDSN IP address, a current paging zone identification PZID of the MS and a current sub-paging zone identification SPZ_ID of the MS.

27. A Content Proxy Server as in claim 26, where the response to the query further comprises a static IP address of the MS.

28. A Content Proxy Server as in claim 26, where the response to the query further comprises the International Mobile Subscriber Identity IMSI of the MS.

29. A Content Proxy Server as in claim 24, where said controller forwards the stored data to the current PDSN reported in the location tuple.

30. A Content Proxy Server as in claim 27, where for the case where the response to the query further comprises the static IP address of the MS, said controller forwards the data to a Home Agent HA the PDSN IP Address, the PZID and the SPZ_ID information, whereby the HA determines if there is a mobile IP association for the MS, and if there is the HA forwards the data to a corresponding PDSN, otherwise the HA forwards the data to the IP address of the PDSN reported in the location information.

31. A Content Proxy Server as in claim 24, where a Network Access Identifier NAI of the MS and an Internet Protocol IP address of the Content Proxy Server are sent to the CN from the MS, where the data sent from the CN to the Content Proxy Server includes the NAI, and where the query issued to the AAA server comprises the NAI.

32. A method to operate a wireless network with a mobile station MS, comprising:
registering the MS with a correspondent node CN;
sending data from the CN to a Content Proxy Server identified by the MS;
determining a current location of the MS with the Content Proxy Server; and
initiating a Network Initiated Data Session NIDS for the MS at its current location.

33. A method as in claim 32, further comprising, in response to the MS obtaining an IP address, routing the data from the Content Proxy Server to the MS at its current location.

34. A method as in claim 32, further comprising, in response to the MS obtaining an IP address, re-registering the MS with the CN, and sending the data from the CN to the MS at its current location.

35. A method as in claim 32, where registering comprises sending a Network Access Identifier NAI of the MS and an Internet Protocol IP address of the Content Proxy Server to the CN from the MS, where the data sent from the CN to the Content Proxy Server includes the NAI, and where the Content Proxy Server determines the current location of the MS by sending a query to a home Authentication, Authorization and Accounting AAA server, the query comprising the NAI.

36. A wireless network comprising a mobile station MS operable for registering the MS with a correspondent node CN, said wireless network further coupled to a Content Proxy Server, said CN sending data to said Content Proxy Server that is identified by the MS when registering with the CN, said Content Proxy Server operating to determine a current location of the MS and to initiate a Network Initiated Data Session NIDS for the MS at its current location.

37. A wireless network as in claim 36, where said Content Proxy Server is responsive to the MS obtaining an IP address for routing the data from the Content Proxy Server to the MS at its current location.

38. A wireless network as in claim 36, where the MS is responsive to obtaining an IP address for re-registering with the CN so that the CN sends the data to the MS at its current location.

39. A wireless network as in claim 36, where the MS when registering sends a Network Access Identifier NAI of the MS and an Internet Protocol IP address of the Content Proxy Server to the CN, where the data sent from the CN to the Content Proxy Server includes the NAI, and where the Content Proxy Server determines the current location of the MS by sending a query to a home Authentication, Authorization and Accounting AAA server, the query comprising the NAI.

40. A mobile station MS operable in a wireless network that comprises a base station BS, said MS comprising a transmitter for sending a registration request via the BS to a correspondent node CN, said wireless network being coupled to a Content Proxy Server, said CN sending data to said Content Proxy Server that is identified by the MS when sending the registration request to the CN, said Content Proxy Server operating to determine a current location of the MS and to initiate a Network Initiated Data Session NIDS for the MS at its current location, said MS further comprising a receiver to receive data sourced by the CN, via the BS, at its current location.

41. A MS as in claim 40, where said Content Proxy Server is responsive to the MS obtaining an IP address for routing the data from the Content Proxy Server to the MS at its current location.

42. A MS as in claim 40, where the MS is responsive to obtaining an IP address for re-registering with the CN so that the CN sends the data to the MS at its current location.

43. A MS as in claim 40, where the MS, when sending the registration request, sends a Network Access Identifier NAI of the MS and an Internet Protocol IP address of the Content Proxy Server to the CN, where the data sent from the CN to the Content Proxy Server includes the NAI, and where the Content Proxy Server determines the current location of the MS by sending a query to a home Authentication, Authorization and Accounting AAA server, the query comprising the NAI.

44. A base station BS operable in a wireless network comprising a mobile station MS, said BS comprising a receiver for receiving a registration request from the MS for a correspondent node CN, said wireless network being coupled to a Content Proxy Server, said CN sending data to said Content Proxy Server that is identified by the MS when sending the registration request to the CN, said Content Proxy Server operating to determine a current location of the MS and to initiate a Network Initiated Data Session NIDS for the MS at its current location, said BS further comprising a transmitter to transmit data sourced by the CN to the MS at its current location.

45. A BS as in claim 44, where said Content Proxy Server is responsive to the MS obtaining an IP address for routing the data from the Content Proxy Server to the MS at its current location, via the BS.

46. A BS as in claim 44, where the MS is responsive to obtaining an IP address for re-registering with the CN so that the CN sends the data to the MS at its current location via the BS.

47. A BS as in claim 44, where the MS, when sending the registration request, sends a Network Access Identifier NAI of the MS and an Internet Protocol IP address of the Content Proxy Server to the CN, where the data sent from the CN to the Content Proxy Server includes the NAI, and where the Content Proxy Server determines the current location of the MS by sending a query to a home Authentication, Authorization and Accounting AAA server, the query comprising the NAI.
